(19) United States
(12) Patent Application Publication
(10) Pub. No.: US 2004/0260547 A1
(43) Pub. Date: Dec. 23, 2004

(54) Signal-to-noise mediated speech recognition algorithm

(75) Inventors: Jordan Cohen, Gloucester, MA (US); Daniel L, Roth, Boston, CA (US); Laurence S. Gillick, Newton, MA (US)

Correspondence Address: WILMER CUTLER PICKERING HALE AND DORR LLP, 60 STATE STREET, BOSTON, MA, 02109, US

(73) Assignee: Voice Signal Technologies

(21) Appl. No.: 10/842,333

(22) Filed: May 10, 2004

Related U.S. Application Data
(60) Provisional application No. 60/469,627, filed on May 8, 2003.

(51) Int. Cl. G10L 15/00

(52) U.S. Cl. 704/233

(57) ABSTRACT

A method of processing speech in a noisy environment includes determining, upon a wake-up command, when the environment is too noisy to yield reliable recognition of a user's spoken words, and alerting the user that the environment is too noisy. Determining when the environment is too noisy includes calculating a ratio of signal to noise. The signal corresponds to of an amount of energy in the spoken utterance, and the noise corresponds to an amount of energy in the background noise. The method further includes comparing the signal to noise to a threshold.

### CROSS-REFERENCE TO RELATED APPLICATIONS

This application claims benefit U.S. Provisional Patent Application Ser. No. 60/469,627, filed May 8, 2003.

### TECHNICAL FIELD

This invention relates generally to wireless communication devices with speech recognition capabilities.

### BACKGROUND

Wireless communications devices, such as cellular telephones (cell phones), commonly employ speech recognition algorithms that enable a user to operate the device in a hands-free and eyes-free manner. For example, many cell phones that are currently on the market can recognize and execute spoken commands to initiate an outgoing phone call, to answer an incoming phone call, and to perform other functions. Many of those cell phones can also recognize a spoken name, locate the recognized name in an electronic phone book, and then automatically call the telephone number associated with the recognized name.

Speech recognition algorithms tend to perform better when the environment in which the user is operating the device has low background noise, i.e., when the signal-to-noise (SNR) of the speech signal is high. As the background noise level increases, the SNR of the speech signal decreases, and the error rate of a speech recognition algorithm typically goes up. That is, the spoken word is either not recognized at all or is recognized incorrectly. This tends to especially be a problem in the case of cell phones and other mobile communication devices in which the available computational power and memory is severely limited due to the small size of the smaller platform. Moreover, cell phones and those other mobile communication devices tend to be used in noisy environments. For example, two locations in which cell phones are commonly used are in the car and on busy city streets. In the car, especially if it is being driven on the highway, the speech signal will be mixed with a significant amount of car noise (e.g. the noise made by the tires against the pavement, the noise made by the air passing over the car, music from the radio, etc.). And on the busy city street, the speech signal will be mixed with traffic noises, car horns, the voices of other nearby people talking, etc.

### SUMMARY OF THE INVENTION

The described embodiment informs a cell phone user when the speech environment is too noisy for reliable operation of the embedded voice recognizer. The cell phone user can then take steps to increase the SNR, e.g., by either speaking more loudly or by reducing the noise level.

In one aspect, a method of performing speech recognition on a mobile device includes receiving a spoken utterance from a user of the mobile device, and processing a signal derived from the received spoken utterance with a speech recognition algorithm. The processing of the derived signal also involves determining whether the environment in which the utterance was spoken is too noisy to yield reliable recognition of the spoken utterance. The method further includes performing an action to improve recognition of the content of the spoken utterance by the speech recognition algorithm, if processing of the derived signal determines that the environment is too noisy to yield reliable recognition of the spoken utterance.

The action to improve recognition of the content of the spoken utterance may involve alerting the user that there was too much noise to permit reliable recognition of the spoken utterance. The action may involve asking the user to repeat the utterance, or generating an audio signal, or generating a visual signal. The action may involve a mechanical vibration of the mobile device.

The action to improve recognition of the content of the spoken utterance may include modifying the speech recognition algorithm to improve recognition performance in the environment in which the utterance was spoken. The speech recognition algorithm may include an acoustic model, where modifying the speech recognition algorithm involves changing the acoustic model. The speech recognition algorithm may include an acoustic model that is parameterized to handle different levels of background noise, where modifying the speech recognition algorithm involves changing parameters in the acoustic model to adjust for the level of background noise.

The step of determining whether the environment in which the utterance was spoken is too noisy to yield reliable recognition may include computing a signal-to-noise ratio for the received utterance, and comparing the computed signal-to-noise ratio to a threshold.

In another aspect, an embodiment includes a computer readable medium storing instructions which, when executed on a processor system, causes the processor system to employ a speech recognition algorithm to process a signal derived from an utterance spoken by a user. The instructions executed on the processor system further determine whether the environment in which the utterance was spoken is too noisy to yield reliable recognition of the spoken utterance. If it is determined that the environment is too noisy to yield reliable recognition of the spoken utterance, the instructions executed on the processor system perform an action to improve recognition of the content of the spoken utterance by the speech recognition algorithm.

The stored instructions executed on the processor system cause the processor system to perform the action by alerting the user that there was too much noise to permit reliable recognition of the spoken utterance, or the instructions cause the processor system to determine whether the environment in which the utterance was spoken is too noisy to yield reliable recognition by computing a signal-to-noise ratio for the spoken utterance. The stored instructions executed on the processor system may cause the processor system to determine whether the environment in which the utterance was spoken is too noisy to yield reliable recognition by also comparing the computed signal-to-noise ratio to a threshold.

The instructions executed on the processor system may cause the processor system to perform the action by modifying the speech recognition algorithm to improve recognition performance in the environment in which the utterance was spoken. In one embodiment, the speech recognition algorithm includes an acoustic model and wherein the stored instructions cause the processor system to modify the speech recognition algorithm by changing the acoustic model. In another embodiment, the speech algorithm includes an acoustic model that is parameterized to handle different levels of background noise. The stored instructions cause the processor system to modify the speech recognition algorithm by changing parameters in the acoustic model to adjust for the level of background noise.

### BRIEF DESCRIPTION OF THE DRAWINGS

FIG. 1 is a flow diagram of the operation of an embodiment of the invention; and,

FIG. 2 is a high-level block diagram of a smartphone on which the functionality described herein can be implemented.

### DETAILED DESCRIPTION

The described embodiment is a cellular telephone with software that provides speech recognition functionality such as is commonly found on many cell phones that are commercially available today. In general, the speech recognition functionality allows a user to bypass the manual keypad and enter commands and data via spoken words. In this case, the software also determines when the environment in which the cell phone is being used is too noisy to yield reliable recognition of the user's spoken words. In the embodiment that will be described in greater detail below, the software measures a SNR and compares that to a predetermined threshold to determine whether there is too much noise. Upon determining that the environment is too noisy, the cell phone then takes some action to deal with that problem. For example, it either alerts the user of the fact that the environment is too noisy to permit reliable recognition or it modifies the internal speech recognition algorithm to improve the recognition performance in that particular environment.

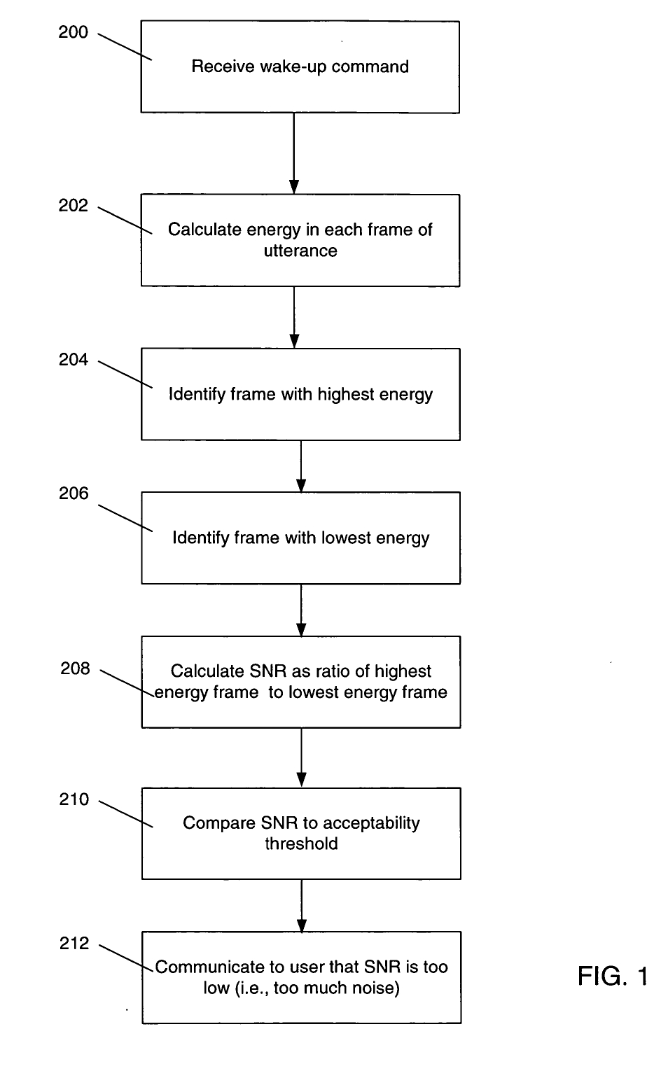

With the help of the flow chart shown in FIG. 1, we will describe the operation of one particular embodiment of the invention. Following that we will describe alternative approaches to detecting when the environment is too noisy and alternative approaches to responding to noisy environments. Finally, we will describe a typical cell phone in which the functionality can be implemented.

The cell phone first receives a wake-up command (block 200), which may be a button-push, a key-stroke, a particular spoken keyword, or simply the beginning of speech from the user. The wake-up command initiates the process that determines whether the speech environment is too noisy. If the wake-up command is a spoken command, the software can be configured to use wake-up command to measure SNR. Alternatively, it can be configured to wait for the next utterance received from the user and use that next utterance (or some portion of that utterance) to measure SNR.

To determine the SNR, voice recognition software calculates the energy as a function of time for the utterance (block 202). It then identifies the portion of the utterance having the highest energy (block 204) and it identifies the portion having the lowest energy (block 206). The software uses those two values to compute an SNR for the utterance (block 208). In this case, the SNR is simply the ratio of the highest value to the lowest value.

In the described embodiment, the recognition software processes the received utterance on a frame-by-frame basis where each frame represents of a sequence of samples of the utterance. For each frame, the software computes an energy value. It does this by integrating the sampled energy over the entire frame so that the computed energy value represents the total energy for the associated frame. At the end of the utterance (or after some period has elapsed after the beginning of the utterance) the software identifies the frame with the highest energy value and the frame with the lowest energy value. It then calculates the SNR by dividing the energy of the frame with the highest energy value by the energy of the frame with the lowest energy value.

The voice recognition software compares the calculated signal to noise ratio to an acceptability threshold (block 210). The threshold represents that level the SNR must exceed for the speech recognition to produce an acceptably low error rate. The threshold can be determined empirically, analytically, or by some combination of the two. The software also enables the user to adjust this threshold to tune the performance or sensitivity of the cell phone.

If the signal to noise ratio does not exceed the acceptability threshold, the voice recognition software communicates to the user that the signal to noise ratio is too low 212.

If the signal to noise ratio does not exceed the acceptability threshold, the voice recognition software takes steps to address the problem (block 212). In the described embodiment, it does this by discontinuing recognition and simply alerting the user that there is too much noise for reliable recognition to take place. The user can then try to reduce the background noise level (e.g., by changing his location, turning down the radio, waiting for some particularly noisy event to end, etc.). The voice recognition software alerts the user by any one or more of a number of different ways that can be configured by the user including an audio signal (i.e., a beep or a tone), a visual signal (i.e., a message or a flashing symbol on the cell phone display), a tactile signal (e.g., a vibration pulse, if the cell phone is so equipped), or some combination thereof.

If the signal to noise ratio exceeds the acceptability threshold, the voice recognition software continues with normal processing.

The speech recognition algorithms may use other techniques (or combinations of those techniques) for calculating a signal-to-noise ratio for a speech signal. In general, these techniques determine the amount of energy in the incoming speech relative to energy in the non-speech. One alternative technique is to generate an energy histogram over an utterance or a period of time and calculate a ratio of lower energy percentiles versus higher energy percentiles (e.g., 5 percent energy regions versus 95 percent energy regions). Another technique is to use a two-state HMM (Hidden Markov Model) and compute means and variances for the two states, where one of the states represents speech and the other state represents noise.

The speech recognition algorithm can also calculate a statistic that is related to signal-to-noise. This statistic is referred to as an “intelligibility index.” According to this approach, the speech recognition software separates the acoustic frames (or samples within the frames) into discrete frequency ranges, and calculates a high-energy to low-energy ratio for only a subset of those frequency ranges. For example, in a particular environment noise may be predominant in frequencies from 300 Hz to 600 Hz. So, the speech recognition software would calculate the high-energy to low-energy ratio only for energy that falls within that frequency range. Alternatively, the speech recognition software may apply a weighting coefficient to each of the distinct frequency ranges, and calculate a weighted composite high-energy to low energy ratio.

In the embodiment described above, the speech recognition software responds to detecting a low SNR by alerting the user. There are other ways in which it could respond as an alternative to or in addition to sending a simple alert. For example, the speech recognition software can instruct the user either visually or audibly to repeat the utterance. Instead of alerting the user, the speech recognition software could modify the acoustic model to account for the noisy environment to produce a speech recognizer that performs better in that environment.

For example, the speech recognition software could include an acoustic model that has been trained from noisy speech. Such an acoustic model might be parameterized to handle different levels of noise. In that event, the speech recognition software would select the appropriate one of those levels depending upon the calculated signal-to-noise ratio. Alternatively, the acoustic model could be scalable to handle a range of noise levels, in which case the speech recognition software would scale the model that is used according to the calculated signal-to-noise ratio. Still another approach is to employ an acoustic model that is parameterized to handle categories of noise (e.g., car noise, street noise, auditorium noise, etc.), in which case the speech recognition software would select a particular category for the model depending upon user input and/or the calculated signal-to-noise ratio.

Still another approach is to use an acoustic model with a different phonetic inventory to account for a high-noise environment. For example, a high-noise environment may obscure certain consonants (e.g., “p's” and “b's”), so an acoustic model with a phonetic inventory specifically designed to decode with those obscured consonants will perform better in a noisy environment, relative to the default acoustic model.

Yet another approach would be to use an acoustic model with a different classifier geometry to compensate for a low signal-to-noise environment. Such classifiers include HMMs, neural networks, or other speech classifiers known in the art. The speech recognition software may alternatively use an acoustic model with different front-end parameterization to provide better performance in a noisy environment. For example, an acoustic model processing a spectral representation of the acoustic signal may perform better than an acoustic model processing a cepstral representation of the signal, if noise is limited to a particular narrow frequency range. This is because the spectral model can excise the noisy frequency range, whereas the cepstral model cannot.

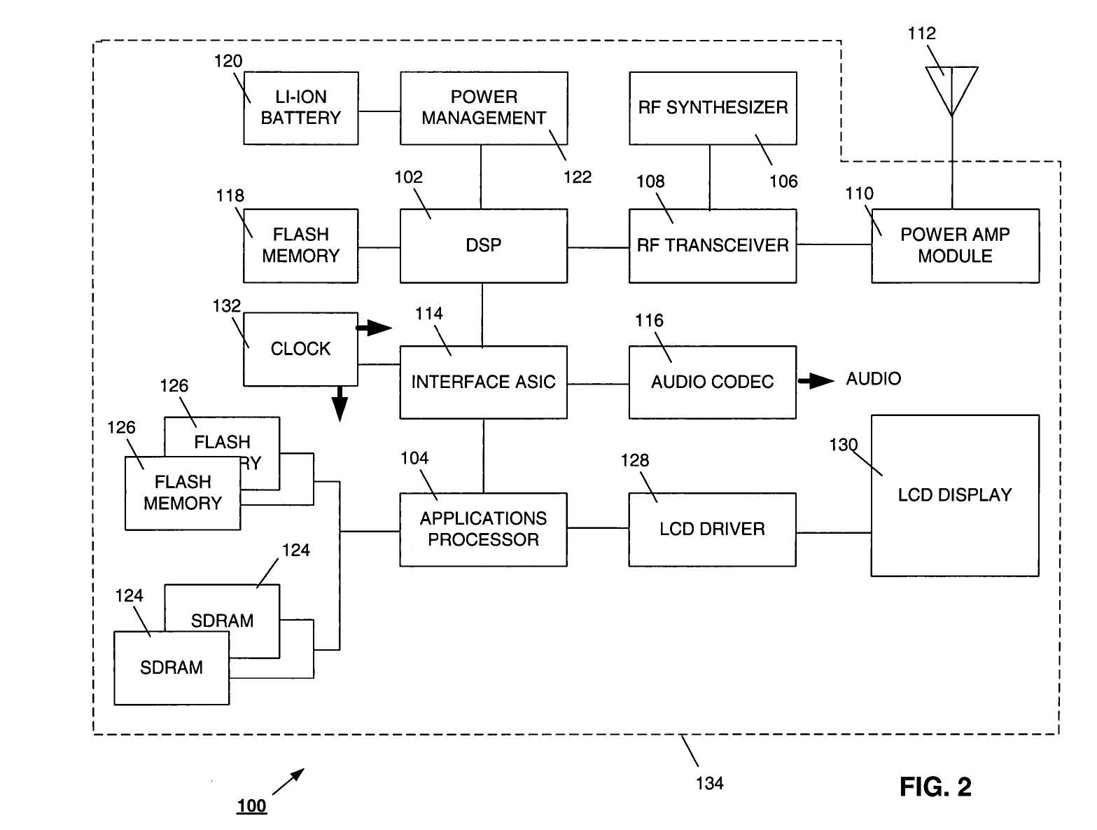

A smartphone 100, as shown in FIG. 2, is an example of platform that can implement the above-described speech recognition functionality. One example of a smartphone 100 is a Microsoft PocketPC-powered phone which includes at its core a baseband DSP 102 (digital signal processor) for handling the cellular communication functions (including for example voiceband and channel coding functions) and an applications processor 104 (e.g. Intel StrongArm SA-1110) on which the PocketPC operating system runs. The phone supports GSM voice calls, SMS (Short Messaging Service) text messaging, wireless email, and desktop-like web browsing along with more traditional PDA features.

An RF synthesizer 106 and an RF radio transceiver 108, followed by a power amplifier module 110 implement the transmit and receive functions. The power amplifier module handles the final-stage RF transmit duties through an antenna 112. An interface ASIC 114 and an audio CODEC 116 provide interfaces to a speaker, a microphone, and other input/output devices provided in the phone such as a numeric or alphanumeric keypad (not shown) for entering commands and information.

DSP 102 uses a flash memory 118 for code store. A Li-Ion (lithium-ion) battery 120 powers the phone and a power management module 122 coupled to DSP 102 manages power consumption within the phone. SDRAM 124 and flash memory 126 provide volatile and non-volatile memory, respectively, for applications processor 114. This arrangement of memory holds the code for the operating system, the code for customizable features such as the phone directory, and the code for any other applications software in the smartphone, including the voice recognition software described above. The visual display device for the smartphone includes an LCD driver chip 128 that drives an LCD display 130. There is also a clock module 132 that provides the clock signals for the other devices within the phone and provides an indicator of real time. All of the above-described components are packages within an appropriately designed housing 134.

Smartphone 100 described above represents the general internal structure of a number of different commercially available smartphones, and the internal circuit design of those phones is generally known in the art.

Other aspects, modifications, and embodiments are within the scope of the following claims.

What is claimed is:

1. A method of performing speech recognition on a mobile device, the method comprising:
receiving a spoken utterance from a user of the mobile device;
processing a signal derived from the received spoken utterance with a speech recognition algorithm, wherein said processing of the derived signal also involves determining whether the environment in which the utterance was spoken is too noisy to yield reliable recognition of the spoken utterance;
if processing of the derived signal determines that the environment is too noisy to yield reliable recognition of the spoken utterance, performing an action to improve recognition of the content of the spoken utterance by the speech recognition algorithm.

2. The method of claim 1, wherein performing the action involves alerting the user that there was too much noise to permit reliable recognition of the spoken utterance.

3. The method of claim 2, wherein alerting also involves asking the user to repeat the utterance.

4. The method of claim 2, wherein alerting involves generating an audio signal.

5. The method of claim 2, wherein alerting involves generating a visual signal

6. The method of claim 2, wherein alerting involves generating a tactile signal

7. The method of claim 6, wherein the tactile signal is a mechanical vibration of the mobile device

8. The method of claim 1, wherein determining whether the environment in which the utterance was spoken is too noisy to yield reliable recognition comprises computing a signal-to-noise ratio for the received utterance.

9. The method of claim 8, wherein determining whether the environment in which the utterance was spoken is too noisy to yield reliable recognition further comprises comparing the computed signal-to-noise ratio to a threshold.

10. The method of claim 1, wherein performing the action involves modifying the speech recognition algorithm to improve recognition performance in the environment in which the utterance was spoken.

11. The method of claim 10, wherein the speech recognition algorithm includes an acoustic model and wherein modifying the speech recognition algorithm involves changing the acoustic model.

12. The method of claim 10, wherein the speech recognition algorithm includes an acoustic model that is parameterized to handle different levels of background noise and wherein modifying the speech recognition algorithm involves changing parameters in the acoustic model to adjust for the level of background noise.

13. A computer readable medium storing instructions which when executed on a processor system causes the processor system to:
employ a speech recognition algorithm to process a signal derived from an utterance spoken by a user;
determine whether the environment in which the utterance was spoken is too noisy to yield reliable recognition of the spoken utterance; and
if it is determined that the environment is too noisy to yield reliable recognition of the spoken utterance, perform an action to improve recognition of the content of the spoken utterance by the speech recognition algorithm.

14. The computer readable medium of claim 13, wherein the stored instructions cause said processor system to perform said action by alerting the user that there was too much noise to permit reliable recognition of the spoken utterance.

15. The computer readable medium of claim 13, wherein the stored instructions cause said processor system to determine whether the environment in which the utterance was spoken is too noisy to yield reliable recognition by computing a signal-to-noise ratio for the spoken utterance.

16. The computer readable medium of claim 13, wherein the stored instructions cause said processor system to determine whether the environment in which the utterance was spoken is too noisy to yield reliable recognition by also comparing the computed signal-to-noise ratio to a threshold.

17. The computer readable medium of claim 13, wherein the stored instructions cause said processor system to perform the action by modifying the speech recognition algorithm to improve recognition performance in the environment in which the utterance was spoken.

18. The computer readable medium of claim 17, wherein the speech recognition algorithm includes an acoustic model and wherein the stored instructions cause said processor system to modify the speech recognition algorithm by changing the acoustic model.

19. The computer readable medium of claim 17, wherein the speech algorithm includes an acoustic model that is parameterized to handle different levels of background noise and wherein the stored instructions cause said processor system to modify the speech recognition algorithm by changing parameters in the acoustic model to adjust for the level of background noise.
